(19) United States
(12) Patent Application Publication
(10) Pub. No.: US 2015/0183450 A1
(43) Pub. Date: Jul. 2, 2015

(54) Baby Stroller Shopping Cart

(71) Applicant: Way-Hong Chen, Taipei City (TW)

(72) Inventor: Way-Hong Chen, Taipei City (TW)

(21) Appl. No.: 14/144,700

(22) Filed: Dec. 31, 2013

(51) Int. Cl. B62B 7/14; B62B 9/26

(52) U.S. Cl. CPC B62B 7/142; B62B 7/14; B62B 9/26

(57) ABSTRACT

A baby stroller shopping cart includes a stroller, a seat assembly mounted on the stroller, and a basket assembly mounted on the stroller. The seat assembly is used to support the baby, and the basket assembly is used to place the items purchased by the user. When the seat assembly is removed from the stroller, the basket assembly co-operates with the stroller to function as a shopping cart individually.

### BACKGROUND OF THE INVENTION

1. Field of the Invention

The present invention relates to a baby stroller shopping cart that bears the baby and functions as a shopping cart.

2. Description of the Related Art

It is inconvenient to carry the baby outdoors so that it is necessary to provide a stroller to place and carry the baby. Usually, a consumer needs to buy a lot of products at a marketplace (especially in the larger shopping malls), so that it is necessary for the consumer to use a shopping cart or basket. However, the consumer has to push the stroller and the shopping cart simultaneously, thereby causing inconvenience to the consumer. In addition, when the stroller is folded, the folded stroller cannot be placed into the shopping cart easily. A modified shopping cart for the marketplace is provided with a seat for placing the baby. However, the baby is not supported by the seat safely, thereby causing danger to the baby when being seated in the seat. In addition, the seat has a simple structure and cannot place the baby comfortably, thereby easily causing an uncomfortable sensation to the baby. A shopping basket for the marketplace can be carried and used by the consumer. However, the consumer has to carry the shopping basket and push the stroller simultaneously, thereby causing inconvenience to the consumer.

### BRIEF SUMMARY OF THE INVENTION

In accordance with the present invention, there is provided a baby stroller shopping cart comprising a stroller, and a basket assembly mounted on the stroller. The stroller includes an inclined outer frame having a lower end and an upper end, at least two front wheels mounted on the lower end of the outer frame, two rear wheel supports pivotally connected with the outer frame, and at least two rear wheels mounted on the rear wheel supports respectively. The basket assembly is removably mounted on the outer frame of the stroller and has a bottom provided with a plurality of castors. Thus, the basket assembly co-operates with the stroller to provide a shopping function, and is removed from the stroller to be used individually.

The baby stroller shopping cart further comprises a seat assembly mounted on the stroller. The seat assembly is removably mounted on the outer frame of the stroller. The stroller further includes two first mounting blocks each mounted on the outer frame and each formed with a first locking groove, and two second mounting blocks each mounted on the outer frame and each formed with a second locking groove. The seat assembly includes a seat frame, and two connecting blocks each pivotally connected with the seat frame and each provided with a downward protruding first locking plug inserted into the first locking groove of the respective first mounting block to attached the seat assembly to the stroller. The basket assembly includes a rack, a receiving basket mounted on a bottom of the rack for placing articles, and two second locking plug mounted on and protruding downward from two outer sides of the rack and each inserted into the second locking groove of the respective second mounting block to attached the basket assembly to the stroller. The basket assembly further includes a handle pivotally connected with the rack.

According to the primary advantage of the present invention, the seat assembly is used to support the baby, and the basket assembly is used to place the items purchased by the user, so that the baby stroller shopping cart can provide dual functions to support the baby and to place the items purchased by the user.

According to another advantage of the present invention, the seat assembly is removed from the stroller, and the basket assembly co-operates with the stroller, so that the baby stroller shopping cart can function as a shopping cart individually.

According to a further advantage of the present invention, the basket assembly is removed from the stroller and is used individually so that the basket assembly can be directly used outdoors for placing the personal items.

According to a further advantage of the present invention, the baby stroller shopping cart can provide dual functions to function as a stroller and a shopping cart so that the user can push the stroller and the shopping cart simultaneously in a convenient manner.

According to a further advantage of the present invention, the baby is seated on the seat assembly comfortably during the user's shopping, and the user needs not to fold the stroller in the shopping mall.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a baby stroller shopping cart in accordance with the preferred embodiment of the present invention.

FIG. 2 is an exploded perspective view of the baby stroller shopping cart as shown in FIG. 1.

FIG. 3 is a locally enlarged view of the baby stroller shopping cart as shown in FIG. 2.

FIG. 4 is a side view of the baby stroller shopping cart as shown in FIG. 1, wherein the front face of the seat assembly is directed toward the stroller.

FIG. 5 is a side view of the baby stroller shopping cart as shown in

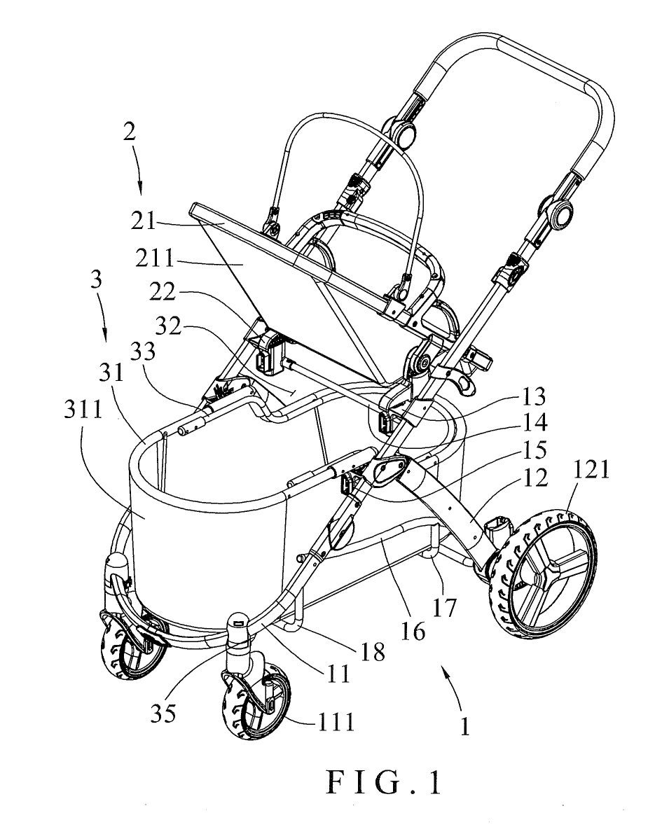

FIG. 1, wherein the back face of the seat assembly is directed toward the stroller.

FIG. 6 is a partially exploded perspective view of the baby stroller shopping cart as shown in FIG. 1.

FIG. 7 is a perspective operational view of a basket assembly of the baby stroller shopping cart as shown in FIG. 1.

FIG. 8 is a perspective operational view of a basket assembly of the baby stroller shopping cart in accordance with another preferred embodiment of the present invention.

### DETAILED DESCRIPTION OF THE INVENTION

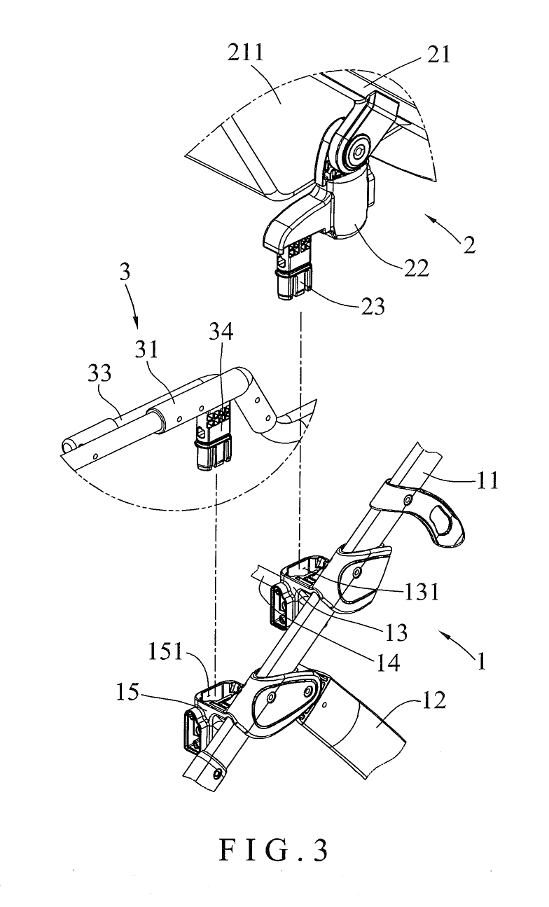

Referring to the drawings and initially to FIGS. 1-4, a baby stroller shopping cart in accordance with the preferred embodiment of the present invention comprises a stroller 1, a seat assembly 2 mounted on the stroller 1, and a basket assembly 3 mounted on the stroller 1.

The stroller 1 has a symmetrical structure and includes an inclined outer frame 11 having a lower end and an upper end, at least two front wheels 111 mounted on the lower end of the outer frame 11, two rear wheel supports 12 pivotally connected with the outer frame 11, at least two rear wheels 121 mounted on the rear wheel supports 12 respectively, two first mounting blocks 13 each mounted on the outer frame 11 and each formed with a first locking groove 131, a seat support bar 14 connected between the first mounting blocks 13, two second mounting blocks 15 each mounted on the outer frame 11 and each formed with a second locking groove 151, two connecting bars 16 each pivotally connected with the outer frame 11 and each pivotally connected with the respective rear wheel support 12, a first bottom support bar 17 connected between the connecting bars 16, and a second bottom support bar 18 mounted on the outer frame 11.

The outer frame 11 of the stroller 1 is an elongate frame consists of a plurality of links. The outer frame 11 of the stroller 1 has two opposite sides each having a mediate portion connected with the respective rear wheel support 12. Each of the first mounting blocks 13 of the stroller 1 is located at the mediate portion of each of the two opposite sides of the outer frame 11. The second mounting blocks 15 of the stroller 1 are disposed beneath the first mounting blocks 13. Each of the second mounting blocks 15 of the stroller 1 is located at the mediate portion of each of the two opposite sides of the outer frame 11. The connecting bars 16 of the stroller 1 are pivotally connected with the two opposite sides of the outer frame 11. Each of the connecting bars 16 of the stroller 1 is disposed under the respective second mounting block 15. The support bar 17 of the stroller 1 is located adjacent to the rear wheels 121. Preferably, the support bar 17 of the stroller 1 has a substantially U-shaped profile. The second bottom support bar 18 of the stroller 1 is connected with the two opposite sides of the outer frame 11 and is located under the connecting bars 16. Preferably, the second bottom support bar 18 of the stroller 1 has a substantially U-shaped profile.

The seat assembly 2 is removably mounted on the outer frame 11 of the stroller 1 and is disposed between the mediate portions of the two opposite sides of the outer frame 11 of the stroller 1. The seat assembly 2 includes a seat frame 21, two connecting blocks 22 each pivotally connected with the seat frame 21 and each provided with a downward protruding first locking plug 23 inserted into the first locking groove 131 of the respective first mounting block 13 to attached the seat assembly 2 to the stroller 1, and a seat cloth 211 mounted on the seat frame 21 for placing the baby.

The basket assembly 3 is removably mounted on the outer frame 11 of the stroller 1 and has a bottom provided with a plurality of castors 35. The basket assembly 3 is disposed between the mediate portions of the two opposite sides of the outer frame 11 of the stroller 1. Thus, the basket assembly 3 co-operates with the stroller 1 to provide a shopping function, and is removed from the stroller 1 to be used individually. The basket assembly 3 includes a rack 31, a receiving basket 311 mounted on a bottom of the rack 31 for placing articles, two second locking plug 34 mounted on and protruding downward from two outer sides of the rack 31 and each inserted into the second locking groove 151 of the respective second mounting block 15 to attached the basket assembly 3 to the stroller 1, and a handle 33 pivotally connected with the rack 31. The rack 31 of the basket assembly 3 is an elongate rack. The rack 31 of the basket assembly 3 has a stepped shape and has an upper first end and a lower second end with a recessed step 32 defined therebetween. The handle 33 of the basket assembly 3 is located at an inner side of the rack 31. The castors 35 of the basket assembly 3 are mounted on the bottom of the receiving basket 311.

In assembly, again referring to FIGS. 1-4, the first locking plug 23 of each of the connecting blocks 22 of the seat assembly 2 is inserted into the first locking groove 131 of the respective first mounting block 13 of the stroller 1 to attached the seat assembly 2 to the stroller 1. At this time, the seat support bar 14 of the stroller 1 abuts the bottom of the seat cloth 211 of the seat assembly 2 to support the baby. Then, each of the second locking plug 34 of the basket assembly 3 is inserted into the second locking groove 151 of the respective second mounting block 15 of the stroller 1 to attached the basket assembly 3 to the stroller 1. At this time, the support bar 17 and the second bottom support bar 18 of the stroller 1 abuts the bottom of the receiving basket 311 of the basket assembly 3 to support the basket assembly 3. In addition, the recessed step 32 of the rack 31 of the basket assembly 3 is directed toward the stroller 1 to facilitate the user placing the purchased articles through the recessed step 32 into the receiving basket 311. In such a manner, the seat assembly 2 is used to support the baby, and the basket assembly 3 is used to place the items purchased by the user, so that the baby stroller shopping cart can offer two functions.

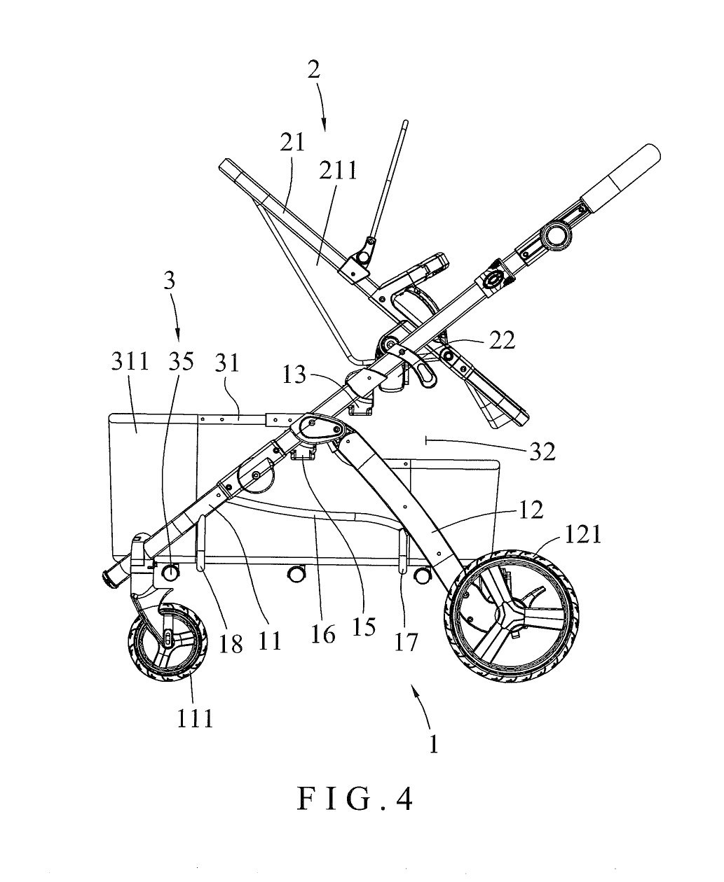

As shown in FIG. 4, the front face of the seat assembly 2 is directed toward the stroller 1.

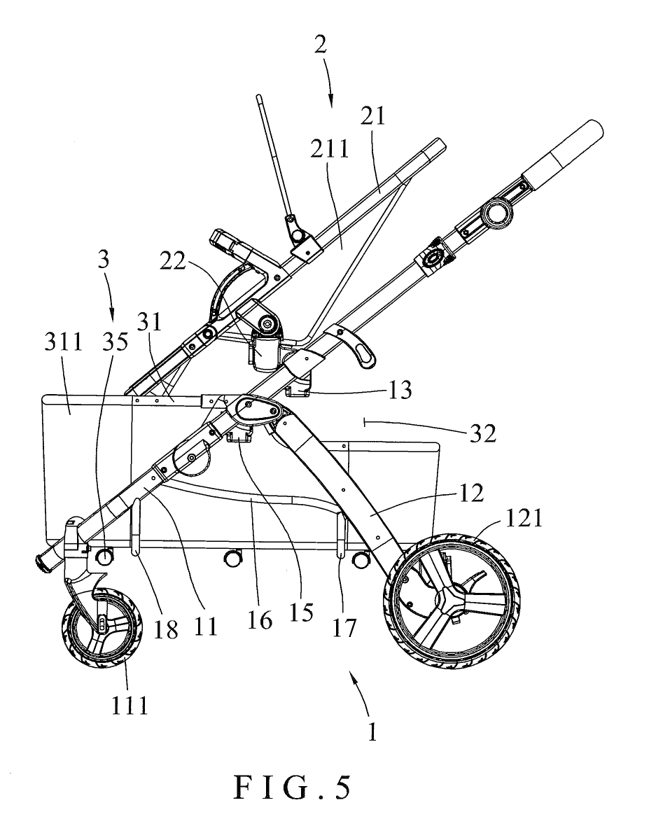

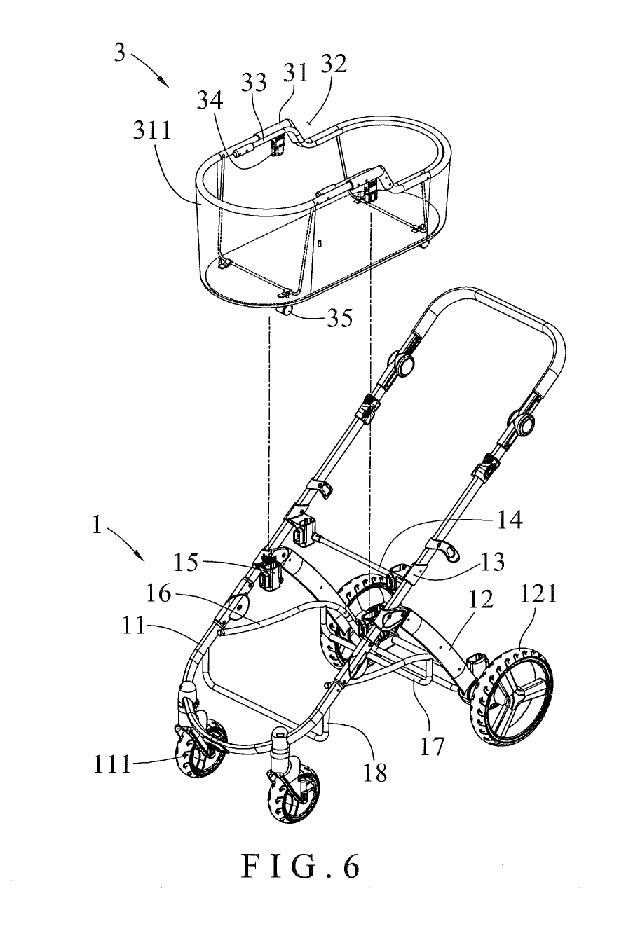

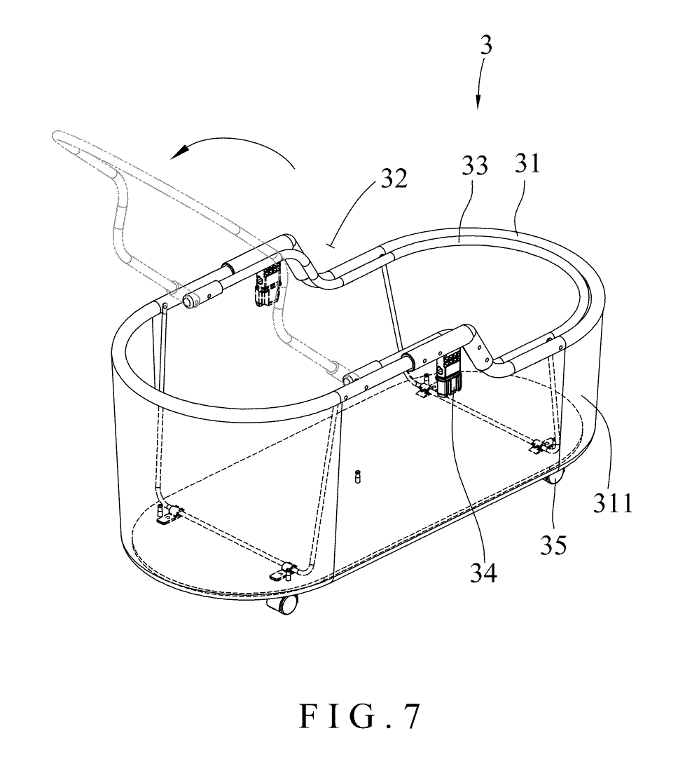

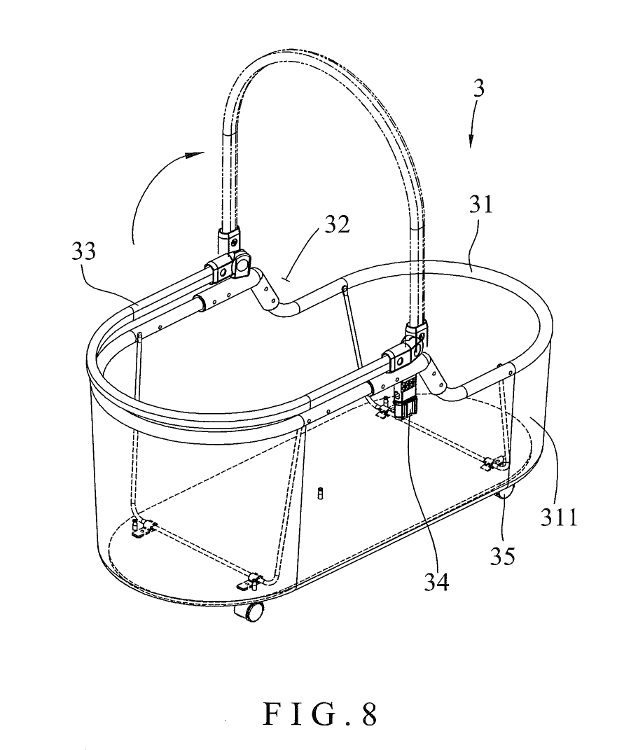

As shown in FIG. 5, the rear face of the seat assembly 2 is directed toward the stroller 1.

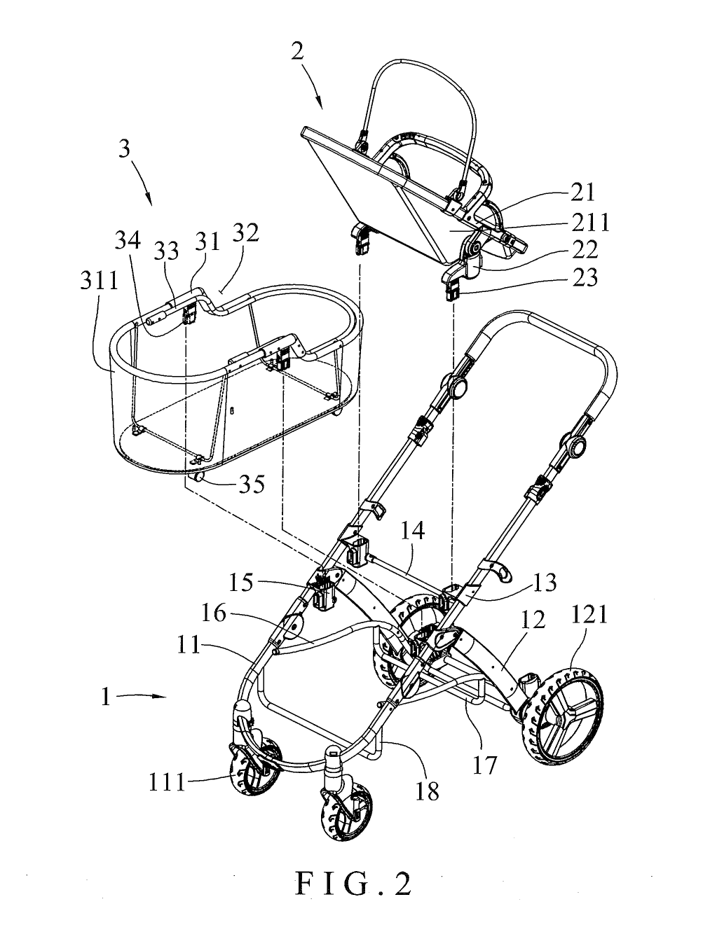

Referring to FIG. 6 with reference to FIGS. 1 and 2, the seat assembly 2 is removed from the stroller 1, and the basket assembly 3 co-operates with the stroller 1 to function as a shopping cart.

Referring to FIG. 7 with reference to FIGS. 1 and 2, the basket assembly 3 is removed from the stroller 1, and is used individually. At this time, the handle 33 of the basket assembly 3 is pivoted relative to and pulled outward from the rack 31, so that the user can use the basket assembly 3 individually. In such a manner, the castors 35 of the basket assembly 3 are moved on the ground to facilitate the user moving the basket assembly 3. Alternatively, the user can directly lift the basket assembly 3 by holding the handle 33 to carry the basket assembly 3.

Referring to FIG. 8, the handle 33 of the basket assembly 3 is located at a top of the rack 31 and has a substantially U-shaped profile.

Accordingly, the seat assembly 2 is used to support the baby, and the basket assembly 3 is used to place the items purchased by the user, so that the baby stroller shopping cart can provide dual functions to support the baby and to place the items purchased by the user. In addition, the seat assembly 2 is removed from the stroller 1, and the basket assembly 3 co-operates with the stroller 1, so that the baby stroller shopping cart can function as a shopping cart individually. Further, the basket assembly 3 is removed from the stroller 1 and is used individually so that the basket assembly 3 can be directly used outdoors for placing the personal items. Further, the baby stroller shopping cart can provide dual functions to function as a stroller and a shopping cart so that the user can push the stroller and the shopping cart simultaneously in a convenient manner. Further, the baby is seated on the seat assembly 2 comfortably during the user's shopping, and the user needs not to fold the stroller 1 in the shopping mall.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A baby stroller shopping cart comprising:
a stroller; and
a basket assembly mounted on the stroller; wherein:
the stroller includes:
an inclined outer frame having a lower end and an upper end;
at least two front wheels mounted on the lower end of the outer frame;
two rear wheel supports pivotally connected with the outer frame; and
at least two rear wheels mounted on the rear wheel supports respectively;
the basket assembly is removably mounted on the outer frame of the stroller and has a bottom provided with a plurality of castors; and
the basket assembly co-operates with the stroller to provide a shopping function, and is removed from the stroller to be used individually.

2. The baby stroller shopping cart of claim 1, further comprising:
a seat assembly removably mounted on the outer frame of the stroller.

3. The baby stroller shopping cart of claim 2, wherein:
the stroller further includes:
two first mounting blocks each mounted on the outer frame and each formed with a first locking groove; and
two second mounting blocks each mounted on the outer frame and each formed with a second locking groove;
the seat assembly includes:
a seat frame; and
two connecting blocks each pivotally connected with the seat frame and each provided with a downward protruding first locking plug inserted into the first locking groove of the respective first mounting block to attached the seat assembly to the stroller;
the basket assembly includes:
a rack;
a receiving basket mounted on a bottom of the rack for placing articles; and
two second locking plug mounted on and protruding downward from two outer sides of the rack and each inserted into the second locking groove of the respective second mounting block to attached the basket assembly to the stroller.

4. The baby stroller shopping cart of claim 3, wherein the stroller further includes:
two connecting bars each pivotally connected with the outer frame and each pivotally connected with the respective rear wheel support;
a first bottom support bar connected between the connecting bars; and
a second bottom support bar mounted on the outer frame.

5. The baby stroller shopping cart of claim 4, wherein:
the support bar of the stroller has a substantially U-shaped profile; and
the second bottom support bar of the stroller has a substantially U-shaped profile.

6. The baby stroller shopping cart of claim 3, wherein the stroller further includes a seat support bar connected between the first mounting blocks.

7. The baby stroller shopping cart of claim 3, wherein the rack of the basket assembly has a stepped shape and has an upper first end and a lower second end with a recessed step defined therebetween.

8. The baby stroller shopping cart of claim 3, wherein:
the basket assembly further includes a handle pivotally connected with the rack; and
the handle of the basket assembly is located at an inner side of the rack.

9. The baby stroller shopping cart of claim 3, wherein:
the basket assembly further includes a handle pivotally connected with the rack; and
the handle of the basket assembly is located at a top of the rack.

10. The baby stroller shopping cart of claim 4, wherein:
the outer frame of the stroller has two opposite sides each having a mediate portion connected with the respective rear wheel support;
each of the first mounting blocks of the stroller is located at the mediate portion of each of the two opposite sides of the outer frame;
the second mounting blocks of the stroller are disposed beneath the first mounting blocks;
each of the second mounting blocks of the stroller is located at the mediate portion of each of the two opposite sides of the outer frame;
the connecting bars of the stroller are pivotally connected with the two opposite sides of the outer frame;
each of the connecting bars of the stroller is disposed under the respective second mounting block;
the support bar of the stroller is located adjacent to the rear wheels; and
the second bottom support bar of the stroller is connected with the two opposite sides of the outer frame and is located under the connecting bars.
